(19) United States
(12) Patent Application Publication
(10) Pub. No.: US 2017/0011330 A1
(43) Pub. Date: Jan. 12, 2017

(54) SIGNALING GAME MACHINE ARCHITECTURE, SYSTEM, SOFTWARE, COMPUTER-ACCESSIBLE MEDIUM AND HARDWARE

(71) Applicant: New York University, New York, NY (US)

(72) Inventors: Bhubaneswar Mishra, Great Neck, NY (US); Larry Rudolph, Boston, MA (US); Joshua Feuer, Brooklyn, NY (US)

(21) Appl. No.: 15/206,943

(22) Filed: Jul. 11, 2016

Related U.S. Application Data
(60) Provisional application No. 62/190,927, filed on Jul. 10, 2015.

(51) Int. Cl. G06Q 10/06; G06F 9/455; G06F 21/62

(52) U.S. Cl. CPC G06Q 10/063114; G06F 21/6245; G06F 9/45533

(57) ABSTRACT

An exemplary system, method and computer accessible medium can be provided that can include generating a digital secure storage area(s) for a user(s), generating, in the secure storage area(s), a module(s) that can include information about the user(s), using a computer-implemented recommender agent(s) to select a receiver(s) to receive the first information and a signal(s) associated with the first information, where receiver(s) can include a verification agent(s), facilitating a verification of the signal(s) by the verification agent, and facilitating the receiver(s) to perform a task(s) based on the verification.

### CROSS-REFERENCE TO RELATED APPLICATION(S)

This application relates to and claims priority from U.S. Patent Application No. 62/190,927, filed on Jul. 10, 2015, the entire disclosure of which is incorporated herein by reference.

### FIELD OF THE DISCLOSURE

The present application relates generally to a computational architecture of a signaling game machine (“SGM”), and more specifically, to exemplary embodiments of an exemplary system, architecture, method and computer-accessible medium for securing privacy, and preserving information flow, from one agent to another through signaling and causing signal-based actions.

### BACKGROUND INFORMATION

One of the limiting factors in efficiently using heterogeneously distributed information available on the Internet can be the lack of transparent mechanisms that can ensure that each agent on the Internet can interact strategically, and can rationally optimize an agent's individual utility. The problem can be further complicated by the need for privacy, trust and security in the mechanisms that implement such strategic interactions.

Just as one can argue in favor of a level playing field to stimulate business competition, in case of societies' use of the Internet, a similar argument translates to evolving towards information parity. However, in reality, there is a dramatic, rapidly growing, information asymmetry among advertisers, web based companies and individual users. While this asymmetry appears to make the situation “unfair” only to a subset of individuals, in reality, it also introduces undesirable global effects which can include, for example: (i) it can be inefficient, (ii) it can lead to deceptive practice and (iii) it can challenge the inherent altruistic norms. The rise in information collection about users, the wholesale aggregation of this information, and the widespread application of machine learning has exacerbated the information asymmetry. In any transaction, each side has its own utility function that can capture what it is that the participant wants to optimize. For instance, it might be profit, brand-loyalty, pleasure, entertainment or getting a job done. When a website understands much of a user's utility function (e.g., because it knows the user's age range, gender, socio-economic status, hobbies, likes and dislikes, etc.), it can be in a good position to exploit this information (e.g., eventually). When a user does not know much about the website's utility function, he or she can be even more likely to be on the losing side of the transaction. The solution of not using the web, being anonymous, using HTTPS, and the use of encrypted information, can just provide temporary relief by addressing only minor annoyances.

Using only well-known, trusted, sites may also not be a solution since trust can be something that must be earned, needs constant monitoring and can stifle innovation. Understanding how to “play a game” when one side knows more than the other can be a newly developing subfield of game theory, captured by “signaling games.” These abstract games can facilitate a user to automatically translate mechanisms for a particular mode of interaction into a mathematical procedure. Were the Internet a universal computational machine to efficiently translate any instance of such signaling games into a hardware-software implementation, the user could solve the underlying problems directly, for example, by a suitable technology, and by also relying on additional software agents. Two kinds of such software agents, Verifiers and Recommenders, can be used to analyze the information flow in a system in a distributed manner so as to adapt to the evolving demands of the system.

Therefore, it can be beneficial to provide an exemplary system, method and computer-accessible medium for overcoming at least some of the deficiencies presented herein above.

### SUMMARY OF EXEMPLARY EMBODIMENTS

An exemplary system, method and computer accessible medium can be provided that can include generating a digital secure storage area(s) for a user(s), generating, in the digital secure storage area(s), a module(s) that can include information about the user(s), with a computer-implemented recommender agent(s), selecting a receiver(s) to receive the first information and a signal(s) associated with the first information, where receiver(s) can include a verification agent(s), facilitating a verification of the signal(s) by the verification agent, and facilitating the receiver(s) to perform a task(s) based on the verification.

In some exemplary embodiments of the present disclosure, a further signal(s) can be generated to be transmitted to the user(s) which can indicate a result of the task(s). A list of a plurality of further recommender agents and a plurality of further verification agents can be generated, and a rank(s) for each further recommendation agent can be generated. The module(s) can include a plurality of modules and the information in each of the modules can be different from the information in another one of the modules. The information can include private information about the user(s).

In certain exemplary embodiments of the present disclosure, the digital secure storage area(s) can be located on a computer of the user. The digital secure storage area(s) can be located on a virtual machine(s), which can be located (i) on a computer of the user or (ii) in a cloud storage. The virtual machine(s) can include a plurality of virtual devices associated with the user(s). The virtual devices can include three virtual devices, wherein a first virtual device of the virtual devices can include random values associated with the user(s), a second virtual device of the virtual devices can include real values associated with the user(s), and a third virtual device of the virtual devices can include mock values associated with the user(s).

In some exemplary embodiments of the present disclosure, the computer-implemented recommender agent(s) can include a plurality of computer-implemented recommended agents each configured to communicate over a recommender private network(s). The verification agent(s) can include a plurality of verification agents each configured to communicate over a verifier private network(s). The module(s) can be an anonymous digital clone of the user(s). A plurality of modules can be generated in the digital secure storage area(s), where each of the modules can be associated with a different user. A meta-clone can be generated based on the plurality of modules, and which may not be anonymous. The information can include health information or financial information. The task(s) can include providing (i) a delivery of ranked pages, (ii) a delivery of songs, (iii) a delivery of movies, (iv) a purchase of goods to be delivered, (v) health advice or (vi) financial advice.

These and other objects, features and advantages of the exemplary embodiments of the present disclosure will become apparent upon reading the following detailed description of the exemplary embodiments of the present disclosure, when taken in conjunction with the appended claims.

### BRIEF DESCRIPTION OF THE DRAWINGS

Further objects, features and advantages of the present disclosure will become apparent from the following detailed description taken in conjunction with the accompanying Figures showing illustrative embodiments of the present disclosure, in which.

FIG. 1 is an exemplary diagram of the exemplary system, method and computer-accessible medium according to an exemplary embodiment of the present disclosure;

FIG. 2 is an exemplary diagram of signaling games according to an exemplary embodiment of the present disclosure;

FIG. 3 is an exemplary diagram of the exemplary system, method and computer-accessible medium being used/accessed from a mobile device or a browser according to an exemplary embodiment of the present disclosure;

FIG. 4 is an exemplary diagram of the exemplary system, method and computer-accessible medium being used with a virtual machine according to an exemplary embodiment of the present disclosure;

FIG. 5 is an exemplary diagram illustrating a verifier private network and a recommender private network according to an exemplary embodiment of the present disclosure;

FIG. 6 is an exemplary flow diagram of an exemplary method for facilitating a receiver to perform a task based on a verification according to an exemplary embodiment of the present disclosure; and

FIG. 7 is an illustration of an exemplary block diagram of an exemplary system in accordance with certain exemplary embodiments of the present disclosure.

Throughout the drawings, the same reference numerals and characters, unless otherwise stated, are used to denote like features, elements, components or portions of the illustrated embodiments. Moreover, while the present disclosure will now be described in detail with reference to the figures, it is done so in connection with the illustrative embodiments and is not limited by the particular embodiments illustrated in the figures and the appended claims.

### DETAILED DESCRIPTION OF EXEMPLARY EMBODIMENTS

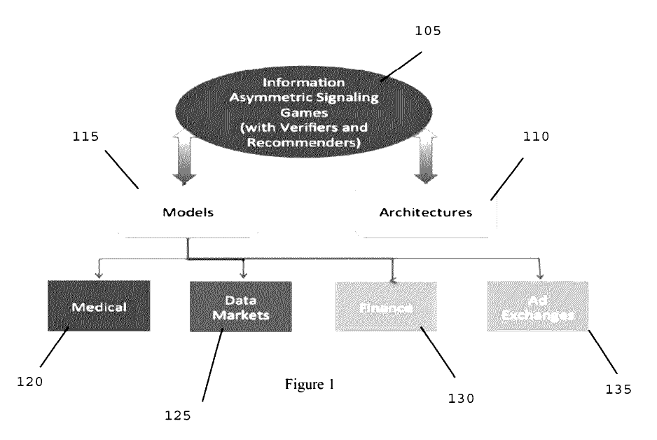

An exemplary embodiment of the present disclosure relates to a computer-accessible medium, which can implement Signaling Games using, for example, clouds, browsers and secure switches. FIG. 1 shows an exemplary diagram of the exemplary system, method and computer-accessible medium according to an exemplary embodiment of the present disclosure. For example, as shown in FIG. 1, an information asymmetric signaling game(s) 105 can include foundational architecture 110, which can be generated with (i) virtual machines facilitating cyber-secure, cross platform, access, (ii) personalization with verifiers and recommenders and (iii) liquid markets via crypto currency and consumer accounts. The information asymmetric signaling game(s) 105 can include, e.g., a model 115, which can be used in various exemplary fields (e.g., medical field 120, data market field 125, finance field 130 and ad exchange field 135).

An information asymmetric signaling game can involve two players: (i) a sender (“S”) and (ii) a receiver (“R”). In such a game, the sender S can be assumed to be informed, and can be assigned as a type t (e.g., in T), which can be kept private, whereas the receiver R can be uninformed, capable of carrying out an action a (e.g., in A), but does not know the private type of the sender. The two can coordinate their activities based on the ambient information that can be provided to the sender S, but upon which the receiver R can act without violating S's privacy. The coordination can be carried using a message (“M”) (e.g., in M) selected from an alphabet. The encoding and decoding of the messages, transmitted from sender S to receiver R, can be coordinated by the signaling game. For example, each agent behaves according to his or her separate utility functions, both of which can depend on the type, message and action. However, their utility functions do not need to be aligned with each other. As can be customary in game theory, the agents can be assumed to be rational, in the sense that they can be utility-optimizing. For the description above, it can be sufficient to assume that their rationality can be bounded, in that they can be utility-satisficing.

A SGM can implement a Signaling Game procedure in hardware (e.g., mobile and cloud), in software (e.g., a virtual machine manager (“VMM”) and/or hyper-visor) and in browser-interfaces (e.g., video-based). Thus the SGM's foundational architecture can be built with (i) virtual machines enabling cyber-secure, cross platform, access, (ii) personalization with verifiers and recommenders and (iii) liquid markets via crypto currency and consumer accounts.

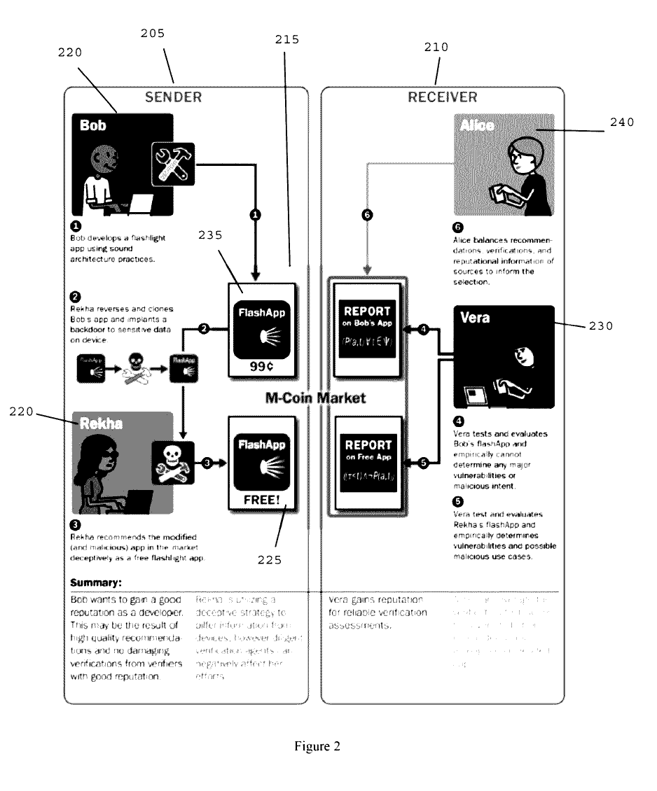

FIG. 2 shows an exemplary diagram of an exemplary signaling game system/method/computer-accessible medium according to an exemplary embodiment of the present disclosure. For example, as shown in FIG. 2, sender side 205 can include a person 220 (e.g., Bob) who develops an app (e.g., a flashlight app 235). Bob's flashlight app 235 is sound, and is not malicious. The flashlight app 235 is placed on a market (e.g., M-coin market 215), for a particular price (e.g., 99 cents). After the app has been placed on market 215, a malicious person 220 (e.g., Rekha) can reverse engineer the app, and create a free malicious version of the app (e.g., free app 225). Rekha can also recommend the free app 225 so that other people will download and use the app. Receiver side 210 can include a tester/verifier 230 (e.g., Vera). Vera tests Bob's flashlight app 230, and determines that it is not malicious. However, when Vera tests free app 225 developed by Rekha, Vera determines that free app 225 is possibly malicious. A user 240 (e.g., Alice) who is looking for a flashlight app will find Bob's flashlight app 235 and Rekha's free app 225. Without Vera performing a verification, Alice would not know that free app 225 is malicious, and Alice may download free app 225 simply because it is free. However, in the exemplary signaling game, Alice can leverage the verification procedures performed by Vera in order to inform her decision about which app to download. While without the signaling game she may have downloaded free app 225, which is malicious, using the signaling game she can avoid the free app 225 and download Bob's flashlight app 235 knowing that it is not malicious.

In an exemplary embodiment of the present disclosure, an informed sender (e.g., a user) can have access to private secure storage, housing types/states and their temporal evolutions. The senders can access the secure storage via a browser (e.g., running on a mobile phone), which can be partitioned into several containers, and each container can hold a specific clone (e.g., a dumb-clone to surf the web, a financial clone to access the bank, another financial clone to access the investments in risky assets, a healthcare clone, etc.) along with a group of verifiers and recommenders (e.g., software agents) specific to the clone's task. Each clone can only “see” an appropriate projection of the true state down to a less informative state, while the virtualized state model, visible to the clone, can maintain an “approximate bisimulation” relation with the true underlying states and their evolutionary trajectories. Any exemplary clone can generate and emit a suitable signal to its intended receiver R (e.g., with the assistance of the verifiers and recommenders). Architecture, very similar to the sender's, can also apply to the receiver. After the signal transmission results in an action, the resulting utilities can be estimated and reported back to each player, who can then respond by modifying their composition of verifiers and recommenders in preparation for the subsequent repetition of signaling games.

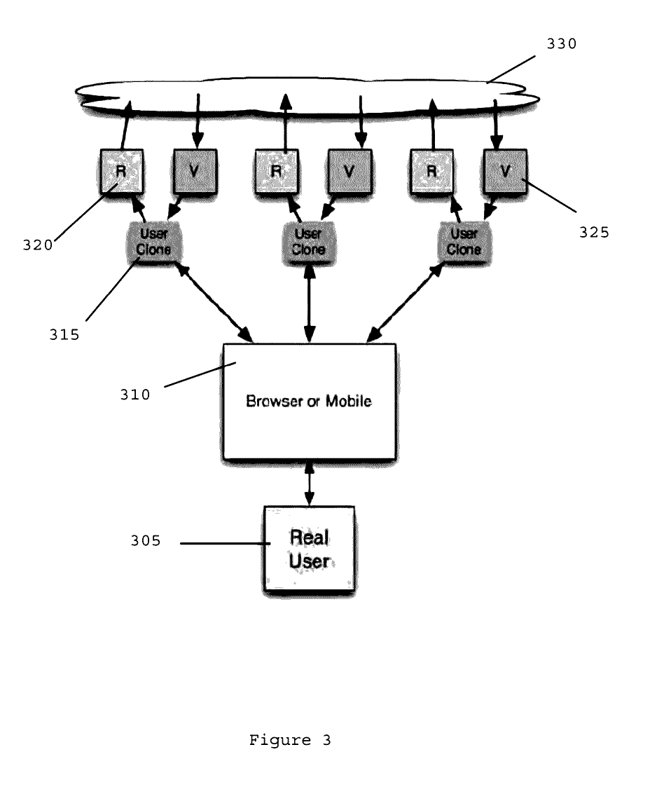

FIG. 3 shows an exemplary diagram of the exemplary signaling game machine used by a user through a mobile device according to an exemplary embodiment of the present disclosure. For example, as shown in FIG. 3, a real user 305 can use a browser or mobile device 310 in order to access and or generate one or more user clones 315. Browser 310 can be partitioned into several containers, and each container can hold a specific user clone 315 (e.g., a dumb-clone to surf the web, a financial clone to access the bank, another financial clone to access the investments in risky assets, a healthcare clone, etc.), along with a group of verifiers and recommenders (e.g., software agents). The user clones 315 can receive information from Vera 325, and can communicate and/or interact with Rekha 320. Rekha 320 can send information into cloud 330, which can be accessed by Vera 325 for verification. Cloud 325 can include a private secure storage, which can house the sender's and receiver's, types/states and their temporal evolutions.

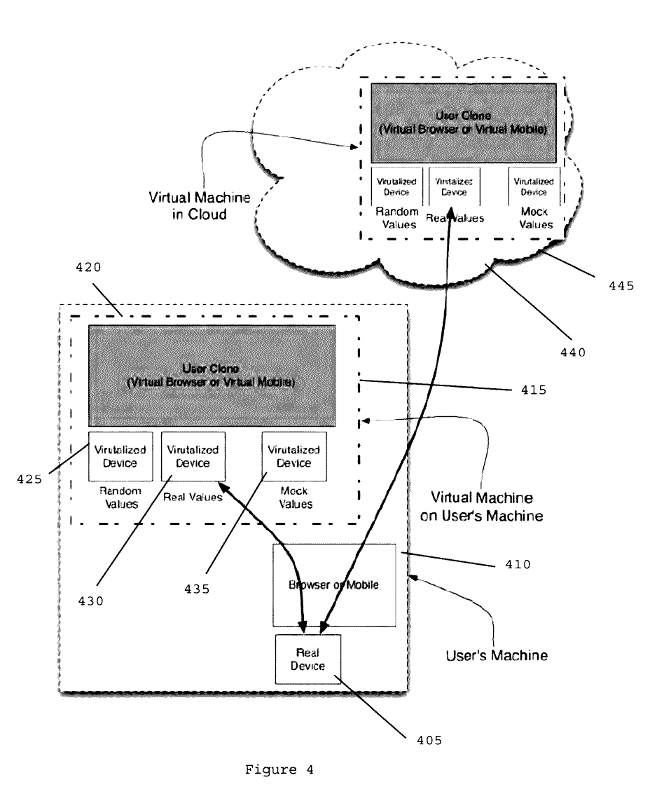

In a further exemplary embodiment of the present disclosure, as shown in the diagram of FIG. 4, a virtual browser or a virtual machine can be used as a user clone. The virtual machine can maintain an “approximate bisimulation” relation with the true underlying states and their evolutionary trajectories. Any exemplary clone, with the help of the verifiers and recommenders, can generate and emit a suitable signal to its intended receiver.

For example, as shown in FIG. 4, a real device 405 can access a browser or mobile device 410, which can be used to create/generate a virtual machine 415 located on the user's machine. Virtual machine 415 can include a user clone 420, and can have access to (i) virtualized device 425 that can include random values associated with real device 405, (ii) virtualized device 430, which can include real values associated with real device 405 and (iii) virtualized device 435, which can include mock values associated with real device 405. In some exemplary embodiments of the present disclosure, the virtual machine can include a cloud-based virtual machine 440, which can be similar to virtual machine 415, however virtual machine 440 can be generated and/or housed in cloud 445.

After the signal transmission by the user clones (which can be, e.g., anonymous) results in an action, the resulting utilities can be estimated and reported back to each player, who can then respond by modifying their composition of verifiers and recommenders in preparation of the subsequent repetition of signaling games. A group of clones from many different individuals can form a coalition to be represented by a virtual meta-clone. Meta-clones can be implemented using a Mix Network. A meta-clone may not be anonymous, as the meta-clone can be monitored, ranked and penalized.

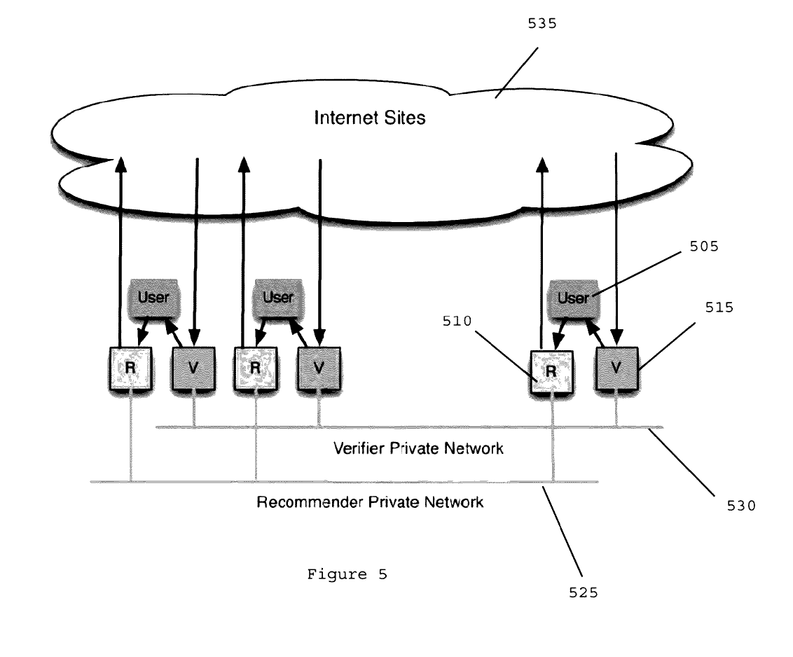

FIG. 5 shows an exemplary diagram illustrating an exemplary verifier private network and an exemplary recommender private network according to an exemplary embodiment of the present disclosure. For example, as shown in FIG. 5, a user can communicate/interact with Rekha 510 (e.g., a recommender) and Vera 515 (e.g., a verifier). Multiple Rekhas (e.g., multiple recommenders) can communicate over a recommender private network 525. Multiple Veras (e.g., multiple verifiers) can communicate over a verifier private network 530. The multiple Rekhas 510 can recommend digital objects 535 (including internet sites) to the user, and the multiple Veras can verify the digital objects 535 that have been recommended by the multiple Rekhas 510.

The exemplary SGM architecture can complicate the underlying game even further, as in many situations it can be desirable that the true identity of the players may not be revealed to the other players. For this purpose, a group of clones from many different individuals can form a coalition, to be represented by a virtual meta-clone, existing in the system independently, and orthogonally to the individual atomic clones. A virtual meta-clone can play a signaling game on behalf of the constituent clones.

Once a signal leaves a meta clone into the network, an external observer can see the signals, but only coming from an anonymous clone, similar in principle to the operation of a Mix Network

Since meta-clone may not be anonymous, the meta-clone can be monitored, ranked and penalized directly, but its clones only indirectly, should any of its members misbehave. If an individual's clone wishes to join such a coalition, as described above, it must choose one, whose constituent members can be rational and statistically indistinguishable, thus conferring a high degree of anonymity and privacy. This can entail that others in the coalition have similar utilities so that their signals can be statistically indistinguishable. It can also be beneficial for the others in the coalition to be reputable (e.g., good verifiers, recommenders and reputation), as otherwise the collective meta-clone can get punished for any single members' bad behavior.

When such meta-clones communicate with each other, optionally incorporating a cascade of intervening Mix Networks, a controlled anonymity can be achieved, since a meta-clone still has access to a large amount of temporal data of its members' signals in the right temporal order. This data can be subject to temporal statistical analysis for various purposes (e.g., by verifiers and recommenders) internal to the meta-clone.

The exemplary SGM, which can include senders and receivers along with their verifiers and recommenders, and which can be further empowered with mechanisms for privacy through anonymization and virtualization, may not only be beneficial, but can also be sufficient for efficient implementation of existing and potential signaling games, which together can constitute an evolving Internet. SGM can also exceed the descriptive thrust by further developing a procedural analysis framework to facilitate the development of procedures for ranking, learning and organizing clones, meta-clones and their verifiers and recommenders.

The notion type, message and action can be used above in an abstract framework, and can be interpreted, concretely, to refer to financial or health related information as the sender's types. Similarly, a message can refer to email, texts, instructions, images etc. that can be sent over the network. An action can refer to the delivery of ranked pages, songs or movies, purchase of goods to be delivered, health or finance related advice, etc.

In a signaling game, each agent can behave according to his or her separate utility functions, both of which can depend on the type, message and action. But their utility functions need not be aligned with each other, in that their individual utility functions need not achieve some desired global utility (e.g., social good or a suitably chosen welfare function such as minimum utility).

Using various exemplary assumptions, it may not be difficult to see that the players must reach a Nash equilibrium. These Nash equilibria can fall into one of three exemplary categories: (i) pooling, (ii) semi-pooling and (iii) separating, of which separating equilibria can be the most desirable, but may not always be achievable. Furthermore, such exemplary games can be prone to deceptive moves either by the sender S, the receiver R or both. These issues can open up many interesting procedural questions dealing with privacy, security (e.g., deception avoidance), trust (e.g., correlation of encounter), anarchy and stability.

An example of such an information asymmetric game can occur in what can be called a Google-game, where the sender S keeps his/her “state of ignorance” private, communicates to the receiver R (e.g., the search engine) his/her need for new information by transmitting a key-word, and subsequently, receives the most relevant “content” from the receiver R. However, based on the transmitted key-words from a specific sender S (e.g., with a persistent identity, for example, determined by cookies), the receiver can statistically infer the type of user, and can initiate a series of cascading signaling games. For example starting with an auction of the key-words (e.g., sender types) in an Ad-exchange, followed by another message-exchange between the user and an Ad-server, etc. However, in each of these exemplary signaling games, there can be ample room for deceptive behavior, which can be aided by other peripheral agents involving apps that can collect location information, aggregators that can machine-learn user's utility functions, recommender-engines that can predict the users' future behavior, honey-nets that can trap users in futile message exchanges, etc., thus turning violation of users' privacy, trust and security into a lucrative enterprise.

Other similar examples of complex and intertwined signaling games occur in such examples as a Netflix game (e.g., a receiver R statistically infers the type and utility function of the sender), bit-coin game (e.g., sender S attempts to double-spend his wallet), data-market game (e.g., sender S mis-specifies the goods, for example, spikes a securitized portfolio with lemons), to name just a few. These games can have adverse effects on the users in the forms of breach of security and privacy, loss of trust and evaporating market liquidity. It can be suggested that these can be the best explanation of why the Internet has not been as successful in areas like health-care, payment-systems, sharing economy, etc., as one might have anticipated.

Many of the foundational questions that the exemplary SGM grapples with date back to the very inception of Internet like systems. For example, in the 1945 article of Vannevar Bush (“As We May Think,” The Atlantic, July 1945), Bush proposed the creation of a “memex” system, “a sort of mechanized private file and library,” which would be used in an information asymmetric game, where a sender S with the help of an efficient codebook retrieves an informative “trail” signal (e.g., relevant to sender's current type) and passes it to the receiver R for an insertion action, linking the new trail to the receiver's more general trail thus modifying the receiver's memex. In an exemplary scenario, described in the article, in the context of a discussion on peoples' natural resistance to innovation, the “informed” sender S sends a trail describing Europeans' failure to adopt Turkish crossbow, and the “uninformed” receiver R accepts the trail without recourse for verification. However, subsequent research on European longbow vs. Turkish crossbow seems to point to a more complex picture.

The exemplary SGM's implementation, in contrast to previously system (e.g., Diaspora and openPDS), can include a secure storage in a cloud, a browser with multiple containers for clones with ability to access the secure personal storage, and an anonymizer that can aggregate a coalition of clones. The exemplary SGM can be based on the information-asymmetry aspect of the signaling games, which together can model the dynamics of the Internet, and can give rise to deceptive behavior. The exemplary SGM can facilitate curbing the Internet's deceptive behaviors through procedural, economic and game-theoretic procedures.

In particular, the exemplary SGM can provides a solution as to how these deceptions can be reduced, or eliminated, through the use of costly signaling, credible and non-credible threats, and additional auxiliary players, such as verifiers and recommenders. For example, the verifiers and recommenders can play a significant role by dynamically checking safety and liveness properties for each sender S and/or receiver R. Thus, a verifier can check that given a sender's types whether the receiver's possible actions could be safe, and a recommender can check that given a receiver's proposed action, whether a sender S can be in possession of the suitable type for the game to be continued. These aspects of the exemplary SGM can lead to an overlap with formal procedures involving model checking over suitably expressive modal logic, as has been well developed over the last thirty years.

The exemplary SGM can also incorporate formal procedures for designing new modes of privacy preserving information transmission, further refining such exemplary techniques as the ones employed in differential privacy.

Thus, the exemplary SGM can extend the Internet to include a layer of “middleware” that can validate, secure and even, in some instances, conduct transactions between traditional “users,” that can be, between requesters (e.g., senders S) and responders (e.g., receivers R). Middleware can include a robust ecosystem of virtual agents, executing on, or in conjunction with, browsers, servers etc., which can act on behalf of those users in initiating, supervising and potentially completing those transactions to third-party virtual agents, referred to as “verifiers” and “recommenders,” who can collectively facilitate user-agent evaluations of each other's veracity can be beneficial.

The middleware can also include not only the user and third-party agents, but also a secure and reliable protocol for communications among and between them. The user agents can operate based on parameters specified for them by their respective “owners,” and can be appropriately limited in their spheres of knowledge (e.g., information access) and authority for those owners.

The exemplary SGM can complicate the game somewhat more, as in many situations it can be desirable that the true identity of the players may not be revealed to the other players. For this purpose, a group of clones from many different individuals can form a coalition, to be represented by a virtual meta-clone, existing in the system independently and orthogonally to the individual atomic clones. A virtual meta-clone can play a signaling game on behalf of the constituent clones.

Once a signal can leave a meta-clone into the network, an external observer can see the signals, but only coming from an anonymous clone, similar in principles to the operation of a Mix Network, or onion protocol. However, since the meta-clone may not be anonymous, the meta-clone can be monitored, ranked and penalized directly, when needed, but its clones may only be indirectly, should any of its members misbehave. Note that if an individual's clone wishes to join such a coalition, as described above, it must choose one, whose constituent members can be rational and statistically indistinguishable, thus conferring a high degree of anonymity and privacy. This can entail that others in the coalition have similar utilities so that their signals can be statistically indistinguishable. It can also be beneficial that the others in the coalition be reputable (e.g., good verifiers, recommenders and reputation), as otherwise the collective meta-clone could get punished for any single member's bad behavior. When such meta-clones can communicate with each other, optionally also incorporating a cascade of intervening Mix networks, one can achieve a controlled anonymity, since a meta-clone still has access to a large amount of temporal data of its members' signals in the right temporal order; this data can be subject to temporal statistical analysis for various purposes (e.g., by verifiers and recommenders) internal to the meta-clone. The exemplary SGM's architecture can assume that these simple mechanisms, consisting of senders and receivers along with their verifiers and recommenders, which can include mechanisms for privacy through anonymization and virtualization, may not only be beneficial, but also sufficient for efficient implementation of existing and potential signaling games, which together can constitute an evolving Internet. Thus, the exemplary SGMs can exceed the descriptive thrust, by further focusing on a procedural analysis framework to enable developing procedures for ranking, learning and organizing clones, meta-clones and their verifiers and recommenders.

Currently, people have become accustomed to trusting and depending upon a handful of individual on-line services, though the aggregation and the exemplary actions can seriously violate privacy. Aggregating the music, movies, You-Tube videos that people relish, the sites people visit, the ads people click, can all be features that, taken together, can reveal much about an individual's personality, culture, status and innermost secrets. In addition to the internet protocol (“IP”) and machine addresses, there can be dozens of features used in uniquely identifying one's digital self, which can include such minutiae as where and how one moves a mouse and how one types. Anonymity has proven to be an insufficient protection mechanism. The loss of privacy threatens to restrict users' abilities to experiment in searching for optimal best responses (e.g., needed to get to Nash equilibria), waste resources in accumulating massive but largely unused data, lead to loss of mutual trust needed to build a liquid market, and limits creation of better social goods (e.g., responding to genomic data for better public health).

Thus, the exemplary SGM can provide a bridge to the future, constructed on the building blocks of low-level, simple, scalable and low-overhead mechanisms, which can enable it to present isolated and independent slices of users that cannot be easily correlated. The exemplary SGMs can be provided by virtualization. Virtual machine technology has made phenomenal progress in the past two decades, providing isolation, interposition, encapsulation and portability. These can be precisely the features the exemplary SGMs can build on to enable the users to participate in the information asymmetric environments that can be inherent to Internet; thus obviating needless aggregation. Interactions with each digital entity can be achieved via a unique virtual self, isolated from users' other virtual selves. Cookies, or other digital tracers, from one site can be isolated from all other sites. Thus, for users, interposition can imply that attempts to collect other information, such as machine Id's, location information, router/Wi-Fi addresses, keyboard and touch gestures, and all other physical device drivers, can remain under the control of the user, and not the operating system or application. Each virtual self can be encapsulated into a file, which can then be replicated and migrated to different locations with ease. As individuals, a user can have a collection of virtual selves that can interact in a multitude of signaling games on the user's behalf, but can appear to each of the other users as a single entity. A user can interact with a single browser and mobile device, which can route and interface with the collection of users' virtual selves.

### Exemplary Applications

### Exemplary Ad Markets Applications

An exemplary SGM for the commercial exchange of Internet advertising can be utilized in terms of an information/data market, in which the placement of advertisements can be bought and sold through an intermediary exchange. Current online “ad exchanges” can serve two primary functions: (i) to centralize and merchandise ad placements to a universe of buyers (e.g., advertisers), and (ii) to establish unit pricing for advertisements via real-time, competitive, bidding. A limitation of the current exchange model can be the opacity to buyers of individual user's data during the buying process, and instead creation of aggregated user groups, which can deny buyers one-to-one access to single users. This structure has resulted in less accurate ad targeting, and dilution of return on investment (“ROI”) for buyers as well as undesirable ad-frauds. The exemplary SGM system, for this exemplary application, can have three layers of data: (i) user-level personal data made selectively transparent to buyers, (ii) page-level data appended to individual data, creating (iii) and behavioral, affinity data resulting from the confluence of (i) and (ii). Individual users of the exemplary system therefore can own their personal data; can communicate subsets of these data to an ad exchange which can then offer user-level access to buyers allowing for lifetime ROI calculation rather than ephemeral one-time access. The exemplary system, method and computer-accessible medium, according to an exemplary embodiment of the present disclosure, can utilize a set of recommenders and verifiers, which can match the needs of the buyer with the attributes of the individual user, creating feedback loops which can assure key “campaign goals” can be achieved. The recommenders can thus add liveness to the exemplary system by helping to identify and engage individuals that satisfy advertisers' targeting criteria. Symmetric to the recommenders can be verifiers which can enhance the safety of the system by maximizing the probability of advertisers' success. The success of the exemplary SGM architecture can minimize wasteful spending, and can yield a better advertiser ROI by piercing the opacity of the user layer, and repositioning control of the data market into the hands of individual users.

### Exemplary Finance Applications

Finance can be, in many ways, the ultimate information-asymmetric signaling game. The player with consistently most up-to-date and most accurate information can likely produce the best and the most timely forecasts. There may be no surprise in that such players make the most money. However, as information technology has improved, so has the ability of a small number of players to detect and respond to arbitrages at a high resolution, and high frequency, and it has become unclear what role they play in improving the overall welfare function (e.g., market liquidity), or how they might have exacerbated the risks to the economies with possibilities of unpredictable flash-crashes.

Exemplary solutions involving dark pools (e.g., similar in spirit to verifiers) and recommenders analyzing publicly available information have been implemented, but have not adequately addressed the issues raised above. Thus, the exemplary SGMs can provide a much simpler framework incorporating better exchanges, management of electronic queues, market makers and other “honest” intermediaries. Therefore the exemplary SGMs can lead to the emergence of facilities within the Internets of the future, which can enable even an unsophisticated user to engineer mechanisms with minimal effort.

As an example, in dark pools, the goal can be to both make sense of the signals being sent by others, as well as cloaking your own signals. Thus, these interactions can be modeled as strategic, and among information asymmetric players, with possibly misaligned utility functions. As procedural trading continues to gain in popularity, other similar, but more complex, examples can emerge, thus making the exemplary SGM architecture, involving repeated signaling games, more and more relevant to technology development.

Internet trading systems for the general public are growing in popularity, and can be subject to the same information asymmetry and potential for deception as any of the online commerce sites. Note that the utility functions can be, mostly, aimed at profit maximization. As procedural trading becomes more popular, the theory of repeated signaling games, and thus the exemplary SGMs, can become more relevant.

### Exemplary Health Care Applications

Healthcare information poses several difficult issues, as privacy, government regulation, insurance and moral hazard issues become intricately intertwined and give rise to complex signaling games with patients, care-givers, physicians, insurance companies and pharmaceutical research participating, but with largely misaligned utilities. Nonetheless, it can be possible to create and attach certain “privacy rights” to the data, as it gets transferred over the network, but the ownership and chain of custody remain clearly delineated. In addition, the verifiers can be utilized to keep track of a reputation system such that the exemplary system can evolve towards the optimal “separating equilibria,” where the signals can be interpreted in the best way, supported by accumulating evidence. Also, as in many other domains, the verifiers and recommenders can be needed to properly balance the requirements for “need-to-know,” vs. “need-to-share.” The exemplary approach remains forward-looking as one can expect the emerging field of “genomic medicine” to open up new avenues for proactive, preventive, predictive and personalized medicine, but can also utilize massive amount of raw genomic data to be collected and analyzed without violating HIPAA rules and privacy needs. Another exemplary design feature can involve how the exemplary SGMs can aggregate patient data for public health involving epidemics (e.g., Malaria, Ebola, etc.) or even bio-terrorism, which can utilize planning for precautionary steps involving quarantine, immigration control, population structure and vaccination, and rely on interesting mix of location, genomic and electronic medical record (“EMR”) data.

### Exemplary Data Exchanges Applications

The exemplary SGMs can model an exchange in which ownership rights to data can be transferred through trusted intermediaries. In the context of electronic medical records, the exemplary system, method and computer-accessible medium, according to an exemplary embodiment of the present disclosure can have individual patients who will own their data, can communicate appropriate subsets of data to the expert physicians, and can provide data to pharmaceutical companies engaged in clinical trials. The exemplary system, method and computer-accessible medium, according to an exemplary embodiment of the present disclosure can include a set of recommenders that can match the needs to the right groups of “cases” and “controls,” to participate in the clinical trial (e.g., with their privacy and privileges delineated by various review boards and informed consent agreements). The recommenders can thus add “liveness” to the system by identifying and engaging individuals that can carry out new actions. By mirroring the recommenders symmetrically, there can be verifiers that can keep track of reputation, trustworthiness, success-rates, etc. of various entities in the system. The exemplary verifiers can enhance the “safety” of the system by interrupting possible undesirable transactions in the system.

An exemplary foundational model of Signaling Games, according to an exemplary embodiment of the present disclosure, that can be built on can involve two players. They can be asymmetric in information, and can be called: S, Sender (informed) and R, Receiver (uninformed). Their roles can be sharable and temporal, as the pairs get selected repeatedly from a large population. The senders and receivers can have persistent identity, which can be pseudo-anonymized or anonymized. There can be possible variations involving partial information, distributed actions, coalition formation, etc. An exemplary notion in this game can be that of type: a random variable, whose support can be given by T (e.g., known to Sender S). Also, πT(·)=to denote probability distribution over T as a prior belief of R about the sender's type. However, a procedure to keep the type information securely hidden in a cloud, whose specific informative projection 1(t) can be available to a clone, which can approximately “bisimulate” t via 1(t), can be provided. A round of a game can proceed as follows: Player S learns tεT; S sends to R a signal sεM; and finally R takes an action aεA. Their payoff/utility functions can be known, and they can depend on the type, signal and action. Thus, for example:

u^{iε{S,R}}:T×M×A→ [symbol] .

In this exemplary structure, the players' behavior strategies can be described by the following two sets of probability distributions: (i) μ(·|t), tεT, on M and (ii) α(·|s), sεM, on A. For S, the sender strategy μ can be a probability distribution on signals given types; for example, μ(s|t) can describe the probability that S with type t sends signal s. For R, the receiver strategy α can be a probability distribution on actions given signals; for example, α(a|s) can describe the probability that R takes action a following signal s. A pair of strategies μ and α can be in Nash equilibrium if, and only if, they can be mutually best responses, for example, if each can maximize the expected utility given the other. Thus, for example:

$${\sum }_{t ∈ T , s ∈ M , a ∈ A} {u}^{R} ( t , s , a ) {π}_{T} ( t ) {μ}^{*} ( s \vert t ) ∝ ( a \vert s ) \geq {\sum }_{t ∈ T , s ∈ M , a ∈ A} {u}^{S} ( t , s , a ) {π}_{T} ( t ) μ ( s \vert t ) ∝ ( a \vert s )$$

$${\sum }_{t ∈ T , s ∈ M , a ∈ A} {u}^{R} ( t , s , a ) {π}_{T} ( t ) μ ( s \vert t ) {∝}^{*} ( a \vert s ) \geq {\sum }_{t ∈ T , s ∈ M , a ∈ A} {u}^{R} ( t , s , a ) {π}_{T} ( t ) μ ( s \vert t ) ∝ ( a \vert s )$$

for any μ, α. It can be shown that such a strategy profile (α*, μ*) can exist. The natural models for sender-receiver utility functions can be based on functions that can combine information rates with distortion, as in rate distortion theory (“RDT”). For example, it can be assumed that there can be certain natural connections between the types and actions, as modeled by the functions f_{S} and f_{R} for the sender and receiver respectively. Thus, for example:

f_{S}:T→A;f_{R}:A→T.

The utility functions for each can consist of two weighted-additive terms; one can measure the mutual information with respect to the signals and the other can measure the undesirable distortion, where the weights can be suitably chosen Lagrange constants. Thus, for example:

u^{S}=I(T,M)−λs^{ds}(f,s(t),a),&u^{R}=I(A,M)−λR^{d}^{^{R}}(t,fR(a)),

where I can denote information and d^{R}, d^{S} can denote measures of distortion.

This definition can also capture the notion of deception as follows. The distribution of signals received by R can be given by the probability distribution πM, where, for example:

$${π}_{M} ( s ) = {\sum }_{t ∈ T} {π}_{T} ( t ) μ ( s \vert t ) ,$$

and the distribution of actions produced by R can be given by the probability distribution πA, where, for example:

$${π}_{A} ( a ) = {\sum }_{s ∈ M} {π}_{M} ( s ) ∝ ( a \vert s ) .$$

πT and πA can be probability distributions on T and A respectively. If π̂T can be the probability distribution on T induced by πA under the function fR, then, for example:

\hat{π}_{T}(·):=π_{A}(f_{R}⁻¹(·)).

An exemplary choice of measure for deception can be given by the entropy between the following exemplary probability distributions:

$$Deception \text{:} = Rel . Entropy ( {\hat{π}}_{T} \vert {π}_{T} ) = {\sum }_{t ∈ T} {\hat{π}}_{T} ( t ) {log}_{2} \frac{{\hat{π}}_{T} ( t )}{{π}_{T} ( t )} .$$

This exemplary definition can describe deception from the point of view of the receiver. For the notion of deception from the point of view of the sender, the game can be played several rounds.

Nash equilibria of Signaling Games can be classified normally into Separating Equilibria (e.g., each type t sends a different signal Mt. f^{S}:t→a[Mₜ], etc.) or Pooling Equilibria (e.g., all types t send a single signal s* with probability 1) or an intermediate situation: Semi-Pooling Equilibria. The separating equilibria, when they exist, can be conventional and non-unique.

The exemplary system, method and computer-accessible medium, according to an exemplary embodiment of the present disclosure, can utilize procedural techniques for selecting an almost optimal signaling alphabet (M); the behavioral strategies and Nash equilibria. The exemplary results for the two exemplary scenarios can be compared: (i) when there can be full transparency (M⊃T×A) vs. (ii) when the privacy constrains M to be significantly smaller, but still rich enough to avoid pooling, or highly degenerate semi-pooling, equilibria. Such analysis can pave the way for rigorous competitive analysis, and can provide a better understanding of how privacy and trust requirements can affect the overall welfare function (e.g., min(min_{S}U^{S}, min_{R}U^{R})). The exemplary system, method and computer-accessible medium, according to an exemplary embodiment of the present disclosure, can generate procedures that can efficiently achieve “good” equilibria, while keeping the distortion and deception small. The exemplary solutions can rely on various mechanisms: (i) costly signaling, (ii) credible and non-credible threat, (iii) aligned utilities and (iv) additional players (e.g., game with 2+m+n players: 1 sender, 1 receiver, m verifiers, n recommenders). In particular, how the senders and receivers can use Probably Approximately Correct (“PAC”) learning procedures (see, e.g., Reference 20) in order to devise the best selection of the group of verifiers and recommenders for a specific signaling game can be focused on. The connection to PAC learning can facilitate the exploitation of the procedural and analysis techniques that have already been developed over the last few decades. This exemplary approach can aid in unifying the exemplary system, method and computer-accessible medium into one theoretical procedural framework having many disparate questions and solutions that can be developed independently: (i) deception, learning Probably Approximately Nash Equilibria (“PANE”), (ii) verifiers and recommenders (e.g., for property checking of safety and liveness conditions, respectively), (iii) role of costly signaling (e.g., Internet economy), (iv) non-revelation and privacy, and (v) correlation of encounters and its manifestation as trust.

### Exemplary Convergence and Stability

Although a lot can be known about the conditions for the existence of a Nash equilibrium, unfortunately, a convergence time (e.g., specifically how it depends on the games' mechanisms), though fascinating, remains poorly understood. While simulations under evolutionary game theoretic framework suggest a fast convergence to “reasonably” good equilibria, there can be theoretical results that suggest intractability in general. The exemplary theoretical analysis of these exemplary systems has been promising, but still much remains unexplored. These issues can raise many problems for the framework, because the Internet can be highly dynamic, and the amount of resources (e.g., computational and data) dedicated to recommenders and verifiers can likely to determine the speed of convergence. Similarly, it can be beneficial to understand how the convergence and stability depend on the scalability of the exemplary system in terms of various exemplary parameters: (i) the number of users, (ii) the number of clones/meta-clones and (iii) the number of repeated games? Once the game converges to what appears to be an equilibrium, will it remain stable? Even when it can be possible to prove that a particular game has an equilibrium, can all players recognize such an equilibrium configuration?

### Exemplary Global Emergent Properties

The collection of repeated signaling games, coupled with recommenders and verifiers, can be viewed as a highly dynamic complex, system. Such exemplary systems can typically have unexpected emergent properties. For example, in the context of biological evolution, occurrences of phase-transitions and various 0-1 laws that determine the equilibria (e.g., punctuated evolution) can be seen. The presence of scale-free structures in the socio-technological networks can be directly related to similar phenomena evolving the dynamics of the internet. Can some such properties be identified? As the Internet can be further augmented with “things,” belonging to and symbiont with humans, how would they modify the dynamics?

### Exemplary Effect of Multiple Local Nash Equilibria

The Nash equilibria in signaling games can be conventional, thus suggesting the possibility of multiple (e.g., stable) Nash equilibria, each of which can be equally desirable. The universality of current structure can be taken for granted, but can be threatened by other features: for example, “regional break-down,” deviation from net-neutrality, the “Great Firewall of China,” etc.

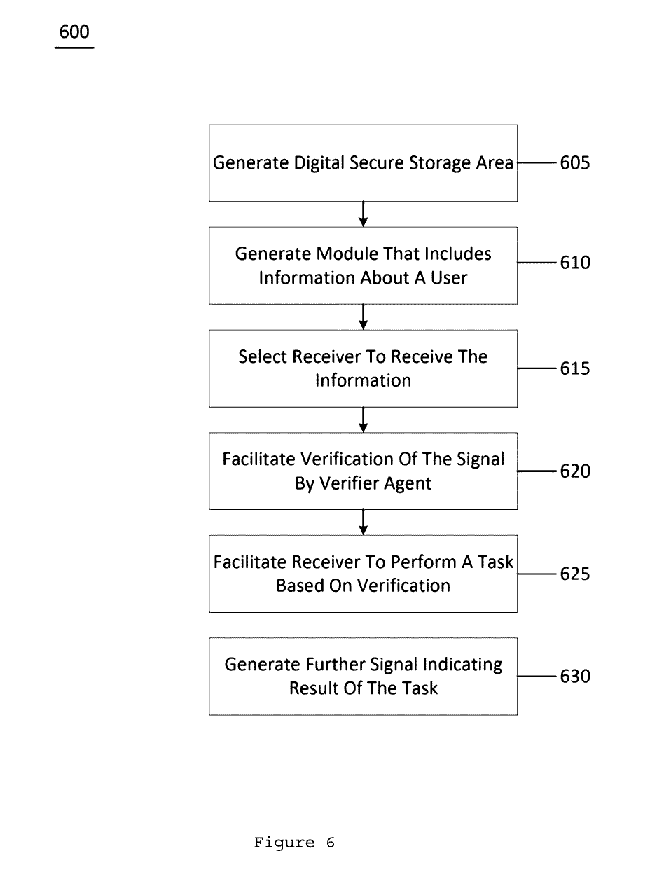

FIG. 6 shows an exemplary flow diagram of an exemplary method 600 for facilitating a receiver to perform a task based on a verification according to an exemplary embodiment of the present disclosure. For example, at procedure 605, at least one digital secure storage area can be generated for at least one user. At procedure 610, at least one module, that includes information about the at least one user, can be generated in the at least one digital secure storage area. At procedure 615, at least one receiver to receive the first information, and at least one signal associated with the first information, can be selected using, for example, at least one computer-implemented recommender agent, where the at least one receiver includes at least one verification agent. At procedure 620, a verification of the at least one signal by the verification agent can be facilitated, and at procedure 625, the at least one receiver can be facilitated to perform at least one task based on the verification. At procedure 630, at least one further signal to be transmitted to the at least one user can be generated, which indicates a result of the at least one task.

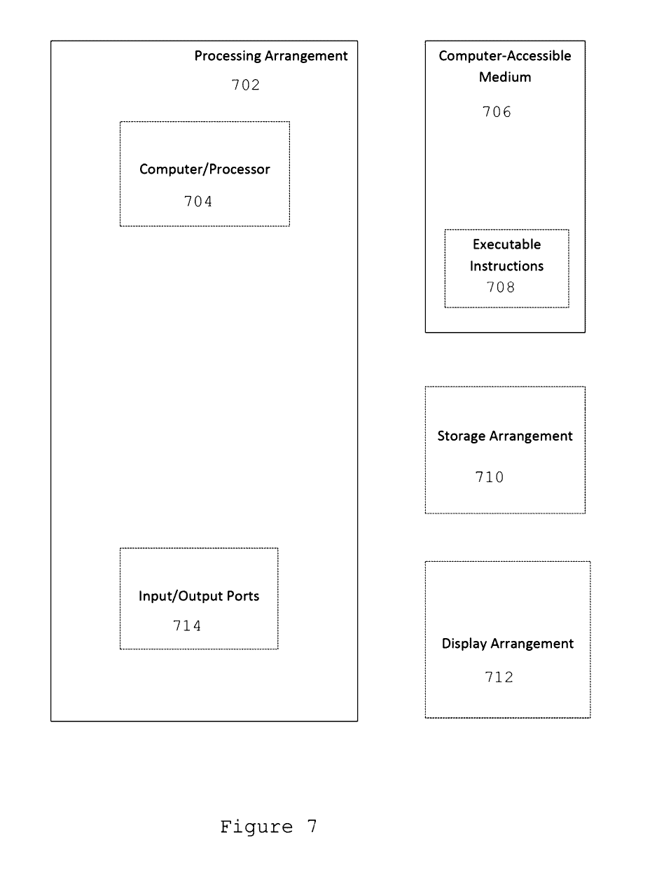

FIG. 7 shows a block diagram of an exemplary embodiment of a system according to the present disclosure. For example, exemplary procedures in accordance with the present disclosure described herein can be performed by a processing arrangement and/or a computing arrangement 702. Such processing/computing arrangement 702 can be, for example entirely or a part of, or include, but not limited to, a computer/processor 704 that can include, for example one or more microprocessors, and use instructions stored on a computer-accessible medium (e.g., RAM, ROM, hard drive, or other storage device).

As shown in FIG. 7, for example a computer-accessible medium 706 (e.g., as described herein above, a storage device such as a hard disk, floppy disk, memory stick, CD-ROM, RAM, ROM, etc., or a collection thereof) can be provided (e.g., in communication with the processing arrangement 702). The computer-accessible medium 706 can contain executable instructions 708 thereon. In addition or alternatively, a storage arrangement 710 can be provided separately from the computer-accessible medium 706, which can provide the instructions to the processing arrangement 702 so as to configure the processing arrangement to execute certain exemplary procedures, processes and methods, as described herein above, for example.

Further, the exemplary processing arrangement 702 can be provided with or include an input/output arrangement 714, which can include, for example a wired network, a wireless network, the internet, an intranet, a data collection probe, a sensor, etc. As shown in FIG. 7, the exemplary processing arrangement 702 can be in communication with an exemplary display arrangement 712, which, according to certain exemplary embodiments of the present disclosure, can be a touch-screen configured for inputting information to the processing arrangement in addition to outputting information from the processing arrangement, for example. Further, the exemplary display 712 and/or a storage arrangement 710 can be used to display and/or store data in a user-accessible format and/or user-readable format.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures which, although not explicitly shown or described herein, embody the principles of the disclosure and can be thus within the spirit and scope of the disclosure. Various different exemplary embodiments can be used together with one another, as well as interchangeably therewith, as should be understood by those having ordinary skill in the art. In addition, certain terms used in the present disclosure, including the specification, drawings and claims thereof, can be used synonymously in certain instances, including, but not limited to, for example, data and information. It should be understood that, while these words, and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

### EXEMPLARY REFERENCES

The following references are hereby incorporated by reference in their entirety.
[1] V. Bush, “As we may think,” p. 6, 1945.
[2] J. Licklider, “Man-computer symbiosis,” Transactions on Human Factors in Electronics, vol. HFE-1, pp. 4-11, 1960.
[3] V. C. Engelbart, “Augmenting human intellect: A conceptual framework,” AFOSR-TR, vol. 3233, p. 30, 1962.
[4] J. Jee, A. Sundstrom, S. Massey, and B. Mishra, “What can information-asymmetric games tell us about the context of crick's frozen accident?,” Journal of The Royal Society Interface, vol. 10, no. 88, p. 8, 2013.
[5] S. Arora, B. Barak, M. Brunnermeier, and R. Ge, “Computational complexity and information asymmetry in financial products,” Commun. ACM, vol. 54, no. 5, pp. 101-107, 2011.
[6] W. Casey, J. A. Morales, T. Nguyen, J. Spring, R. Weaver, E. Wright, L. Metcalf, and B. Mishra, “Cyber security via signaling games: Toward a science of cyber security,” in Distributed Com-puting and Internet Technology—10th International Conference, ICDCIT 2014, Bhubaneswar, India, Feb. 6-9, 2014. Proceedings, pp. 34-42, 2014.
[7] B. Skyrms, Signals: Evolution, Learning, and Information. Oxford University Press, 2010.
[8] S. M. Huttegger and B. Skyrms, “Emergence of information transfer by inductive learning,” Studia Logica, vol. 89, no. 2, pp. 237-256, 2008.
[9] S. M. Huttegger, B. Skyrms, R. Smead, and K. J. S. Zollman, “Evolutionary dynamics of lewis signaling games: signaling systems vs. partial pooling,” Synthese, vol. 172, no. 1, pp. 177-191, 2010.
[10] K. Binmore and L. Samuelson, “Evolution and mixed strategies,” Games and Economic Behav-ior, vol. 34, no. 2, pp. 200-226, 2001.
[11] Y.-A. de Montjoye, E. Shmueli, S. Wang, and A. S. Pentland, “openpds: Protecting the privacy of metadata through safeanswers,” PLoS One, 2014.
[12] G. Bell, “A personal digital store,” Commun. ACM, vol. 44, no. 1, pp. 86-91, 2001.
[13] J. Gemmell, G. Bell, and R. Lueder, “Mylifebits: a personal database for everything,” Commun. ACM, vol. 49, no. 1, pp. 88-95, 2006.
[14] L. Sweeney, “k-anonymity: A model for protecting privacy,” International Journal of Uncer-tainty, Fuzziness and Knowledge-Based Systems, vol. 10, no. 5, pp. 557-570, 2002.
[15] J. J. Cimino, M. E. Frisse, J. Halamka, L. Sweeney, and W. A. Yasnoff, “Consumer-mediated health information exchanges: The 2012 ACMI debate,” Journal of Biomedical Informatics, vol. 48, pp. 5-15, 2014.
[16] C. Dwork and A. Roth, “The algorithmic foundations of differential privacy,” Foundations and Trends in Theoretical Computer Science, vol. 9, no. 3-4, pp. 211-407, 2014.
[17] L. Backstrom, C. Dwork, and J. M. Kleinberg, “Wherefore art thou r3579x?: anonymized social networks, hidden patterns, and structural steganography,” Commun. ACM, vol. 54, no. 12, pp. 133-141, 2011.
[18] D. Chaum, “Untraceable electronic mail, return addresses, and digital pseudonyms,” Commun. ACM, vol. 24, no. 2, pp. 84-88, 1981.
[19] P. F. Syverson, D. M. Goldschlag, and M. G. Reed, “Anonymous connections and onion routing,” in 1997 IEEE Symposium on Security and Privacy, May 4-7, 1997, Oakland, Calif., USA, pp. 44-54, 1997.
[20] L. G. Valiant, “A theory of the learnable,” Commun. ACM, vol. 27, no. 11, pp. 1134-1142, 1984. [21] S. Gilbert and N. A. Lynch, “Perspectives on the CAP theorem,” IEEE Computer, vol. 45, no. 2, pp. 30-36, 2012.
[22] S. Gilbert and N. A. Lynch, “Brewer's conjecture and the feasibility of consistent, available, partition-tolerant web services,” SIGACT News, vol. 33, no. 2, pp. 51-59, 2002.
[23] L. Lamport, R. E. Shostak, and M. C. Pease, “The byzantine generals problem,” ACM Trans. Program. Lang. Syst., vol. 4, no. 3, pp. 382-401, 1982.
[24] C. Dwork and R. Pottenger, “Toward practicing privacy,” JAMIA, vol. 20, no. 1, pp. 102-108, 2013.
[25] R. Greenspan, M. Mitchell, and J. A. Wise, “Shared principles between the computing and biological sciences,” National Science Foundation, p. 15, 2011.
[26] I. Korsunsky, D. Ramazzotti, G. Caravagna, and B. Mishra, “Inference of cancer progression models with biological noise,” CoRR, vol. abs/1408.6032, 2014.
[27] G. Narzisi, B. Mishra, and M. C. Schatz, “On algorithmic complexity of biomolecular sequence assembly problem,” in Algorithms for Computational Biology—First International Conference, AlCoB 2014, Tarragona, Spain, July 1-3, 2014, Proceedings, pp. 183-195, 2014.
[28] L. O. Loohuis, A. Witzel, and B. Mishra, “Improving detection of driver genes: Power-law null model of copy number variation in cancer,” IEEE/ACM Trans. Comput. Biology Bioinform., vol. 11, no. 6, pp. 1260-1263, 2014.
[29] L. O. Loohuis, A. Witzel, and B. Mishra, “Cancer hybrid automata: Model, beliefs and therapy,” Inf. Comput., vol. 236, pp. 68-86, 2014.
[30] J. Jee, L. C. Klippel, M. S. Hossain, N. Ramakrishnan, and B. Mishra, “Discovering the ebb and flow of ideas from text corpora,” IEEE Computer, vol. 45, no. 2, pp. 73-77, 2012.
[31] A. Sundstrom, S. Cirrone, S. Paxia, C. Hsueh, R. Kjolby, J. K. Gimzewski, J. Reed, and B. Mishra, “Image analysis and length estimation of biomolecules using AFM,” IEEE Transac-tions on Information Technology in Biomedicine, vol. 16, no. 6, pp. 1200-1207, 2012.
[32] F. Vezzi, G. Narzisi, and B. Mishra, “Reevaluating assembly evaluations with feature response curves: GAGE and assemblathons,” CoRR, vol. abs/1210.1095, 2012.
[33] S. Kleinberg and B. Mishra, “The temporal logic of causal structures,” CoRR, vol. abs/1205.2634, 2012.
[34] L. O. Loohuis, A. Witzel, and B. Mishra, “Towards cancer hybrid automata,” in Proceedings First International Workshop on Hybrid Systems and Biology, H S B 2012, Newcastle Upon Tyne, UK, 3rd September 2012., pp. 137-151, 2012.
[35] F. Menges, G. Narzisi, and B. Mishra, “Totalrecaller: improved accuracy and performance via integrated alignment and base-calling,” Bioinformatics, vol. 27, no. 17, pp. 2330-2337, 2011.
[36] G. Narzisi and B. Mishra, “Scoring-and-unfolding trimmed tree assembler: concepts, constructs and comparisons,” Bioinformatics, vol. 27, no. 2, pp. 153-160, 2011.
[37] A. Mitrofanova, V. Pavlovic, and B. Mishra, “Prediction of protein functions with gene ontol-ogy and interspecies protein homology data,” IEEE/ACM Trans. Comput. Biology Bioinform., vol. 8, no. 3, pp. 775-784, 2011.
[38] S. Kleinberg and B. Mishra, “The temporal logic of token causes,” in KR, 2010.
[39] A. Mitrofanova, S. Kleinberg, J. Carlton, S. Kasif, and B. Mishra, “Predicting malaria interac-tome classifications from time-course transcriptomic data along the intraerythrocytic develop-mental cycle,” Artificial Intelligence in Medicine, vol. 49, no. 3, pp. 167-176, 2010.
[40] A. Mitrofanova, M. Farach-Colton, and B. Mishra, “Efficient and robust prediction algorithms for protein complexes using gomory-hu trees,” in Pacific Symposium on Biocomputing, pp. 215-226, 2009.
[41] B. Mishra, “Technical perspective—where biology meets computing,” Commun. ACM, vol. 52, no. 3, p. 96, 2009.
[42] S. Tadepalli, N. Ramakrishnan, L. T. Watson, B. Mishra, and R. F. Helm, “Simultaneously segmenting multiple gene expression time courses by analyzing cluster dynamics,” J. Bioinfor-matics and Computational Biology, vol. 7, no. 2, pp. 339-356, 2009.
[43] (D. Chaum, “Untraceable electronic mail, return addresses, and digital pseudonyms,” Commun. ACM, vol. 24, no. 2, pp. 84-88, 1981.), or onion protocol.
[44] (P. F. Syverson, D. M. Goldschlag, and M. G. Reed, “Anonymous connections and onion routing,” in 1997 IEEE Symposium on Security and Privacy, May 4-7, 1997, Oakland, Calif., USA, pp. 44-54, 1997.).

What is claimed is:

1. A non-transitory computer-accessible medium having stored thereon computer-executable instructions, wherein, when a computer arrangement executes the instructions, the computer arrangement is configured to perform procedures comprising:
generating at least one digital secure storage area for at least one user;
generating, in the at least one digital secure storage area, at least one module that includes information about the at least one user;
with at least one computer-implemented recommender agent, selecting at least one receiver to receive the first information and at least one signal associated with the first information, wherein the at least one receiver includes at least one verification agent;
facilitating a verification of the at least one signal by the verification agent; and
facilitating the at least one receiver to perform at least one task based on the verification.

2. The computer-accessible medium of claim 1, wherein the computer arrangement is further configured to generate at least one further signal to be transmitted to the at least one user which indicates a result of the at least one task.

3. The computer-accessible medium of claim 1, wherein the computer arrangement is further configured to generate a list of a plurality of further recommender agents and a plurality of further verification agents.

4. The computer-accessible medium of claim 3, wherein the computer arrangement is further configured to generate at least one rank for each further recommendation agent.

5. The computer-accessible medium of claim 1, wherein the at least one module includes a plurality of modules, and wherein the information in each of the modules is different from the information in another one of the modules.

6. The computer-accessible medium of claim 1, wherein the information includes private information about the at least one user.

7. The computer-accessible medium of claim 1, wherein the at least one digital secure storage area is located on a computer of the user.

8. The computer-accessible medium of claim 1, wherein the at least one digital secure storage area is located on at least one virtual machine.

9. The computer-accessible medium of claim 8, wherein the at least one virtual machine is located at least one of (i) on a computer of the user, or (ii) in a cloud storage.

10. The computer-accessible medium of claim 8, wherein the at least one virtual machine includes a plurality of virtual devices associated with the at least one user.

11. The computer-accessible medium of claim 10, wherein the virtual devices include three virtual devices, and wherein:
a first device of the virtual devices includes random values associated with the at least one user,
a second device of the virtual devices includes real values associated with the at least one user, and
a third device of the virtual devices includes mock values associated with the at least one user.

12. The computer-accessible medium of claim 1, wherein the at least one computer-implemented recommender agent includes a plurality of computer-implemented recommended agents each configured to communicate over at least one recommender private network.

13. The computer-accessible medium of claim 1, wherein the at least one verification agent includes a plurality of verification agents, and wherein each of the verification agents is configured to communicate over at least one verifier private network.

14. The computer-accessible medium of claim 1, wherein the at least one module is a an anonymous digital clone of the at least one user.

15. The computer-accessible medium of claim 1, wherein the computer arrangement is further configured to generate, in the at least one digital secure storage area, a plurality of modules, and wherein each of the modules is associated with a different user.

16. The computer-accessible medium of claim 1, wherein the computer arrangement is further configured to generate a meta-clone based on the plurality of modules, and wherein the meta-clone is not anonymous.

17. The computer-accessible medium of claim 1, wherein the information includes at least one of health information or financial information.

18. The computer-accessible medium of claim 1, wherein the at least one task includes providing at least one of (i) a delivery of ranked pages, (ii) a delivery of songs, (iii) a delivery of movies, (iv) a purchase of goods to be delivered, (v) a health advice, or (vi) a financial advice.

19. A method, comprising:
generating at least one digital secure storage area for at least one user;
generating, in the at least one digital secure storage area, at least one module that includes information about the at least one user;
with at least one computer-implemented recommender agent, selecting at least one receiver to receive the first information and at least one signal associated with the first information, wherein the at least one receiver includes at least one verification agent;
facilitating a verification of the at least one signal by the verification agent; and
using a computer hardware arrangement, facilitating the at least one receiver to perform at least one task based on the verification.

20. A system, comprising:
a computer hardware arrangement configured to:
generate at least one digital secure storage area for at least one user;
generate, in the at least one digital secure storage area, at least one module that includes information about the at least one user;
with at least one computer-implemented recommender agent, select at least one receiver to receive the first information and at least one signal associated with the first information, wherein the at least one receiver includes at least one verification agent;
facilitate a verification of the at least one signal by the verification agent; and
facilitate the at least one receiver to perform at least one task based on the verification.
